(19) United States
(12) Patent Application Publication
(10) Pub. No.: US 2025/0229934 A1
(43) Pub. Date: Jul. 17, 2025

(54) LABELING DEVICE, LABELING SYSTEM, METHOD FOR LABELING A PIECE GOOD

(71) Applicant: Körber Supply Chain Logistics GmbH, Konstanz (DE)

(72) Inventors: Thomas Barth, Gottmadingen-Bietingen (DE); Erik Hempel, Konstanz (DE); Thomas Moser, Konstanz (DE); Dirk-Udo Eisser, Reichenau (DE)

(21) Appl. No.: 19/021,831

(22) Filed: Jan. 15, 2025

(30) Foreign Application Priority Data
Jan. 15, 2024 (DE) 10 2024 101 043.6

(51) Int. Cl. B65C 9/44; B65C 9/02; B65C 9/26; B65C 9/40

(52) U.S. Cl. CPC B65C 9/44; B65C 9/02; B65C 9/26; B65C 2009/404

(57) ABSTRACT

A label device for applying a label to a piece good is provided where label device includes a fixed base, a movable arm which is movably mounted on the fixed base, and a function end which is provided on the movable arm, wherein the function end is configured to hold a label, wherein the movable arm is displaceable between a hold state, in which a label can be held on the function end, and an application state, in which the function end can come into contact with the piece good in order to apply the label to the piece good, and a related method.

### BACKGROUND

The present disclosure relates to a label device for applying a label to a piece good, a label system for labeling a piece good and a method for labeling a piece good.

In the state of the art, there are a variety of label or labeling solutions, including automated systems. The basic working mechanism for applying labels to a piece good is to apply them using compressed air, whereby a defined minimum distance must be maintained between the piece good and the label gripper. The piece goods and their positions are mainly detected using simple light barriers. The labels are not pressed on firmly during application because mechanical contact is undesirable. Furthermore, the exact position of the piece goods is not detected, so that no exact measurement of the piece goods takes place, meaning that the labeling process is also very inaccurate. In other words, the position of the label on the piece good can only be detected very imprecisely. Furthermore, the throughput of piece goods of the systems known to date is not adapted to the current efficiency of other handling devices, especially in the postal sector.

Therefore, it is an object of the present disclosure to provide a labeling device that can eliminate at least one disadvantage of the state of the art.

### SUMMARY OF THE INVENTION

According to one aspect of the present disclosure, a label device for applying a label to a piece good is provided. The label device may comprise a stationary base. Further, the label device may comprise a movable arm movably mounted to the fixed base. Furthermore, the label device may comprise a function end provided on the movable arm, wherein the function end is configured to hold a label. Optionally, the movable arm is displaceable between a hold state, in which a label can be held on the function end, and an application state, in which the function end can come into contact with the piece good in order to apply the label to the piece good.

Compared to the known state of the art, the object of the present disclosure provides the advantage that the label is applied by contact with the piece good. The movable arm allows synchronous tracking of the piece good while the label is applied by contact with the piece good. This can ensure that the label is sufficiently well attached to a piece good and adheres to it accordingly. It is also advantageous that a movable arm is used to apply a label to a piece of good. Compared to conventional systems, this offers greater flexibility with regard to the range of piece goods that can be handled with the label device. Furthermore, the movable arm can also take account of movements of the piece goods, which allows the piece goods to be labeled while they are moving. As a result, higher throughput rates (e.g. piece goods per hour) can be achieved.

A label can be understood as a label or other sticker that is attached to a piece good for identification or other information purposes. For example, the label can be a sticker that is indicative of a delivery destination of the piece good. The label may be a paper-like object that has an adhesive or the like on one side, so that the label can be fixed to a piece good upon contact with it. The piece good can be a mail item that goes through a mail piece handling process. For example, the piece good can be a parcel, small parcel, shipping bag, shipping roll, polybag, smalls, or any other goods packaging. Different piece goods can be distinguished in particular by their different surface shape and properties. The labeling device can be an apparatus or device configured to apply a label to the piece good. The fixed base may be, for example, a stand of the device. Furthermore, the fixed base can be an attachment with which the device is fixed in position on a surface or other objects. For example, it is conceivable that the label device is also fixed to a shelving system or other machines. The fixed base can therefore be the point of contact between the label device and a foundation or other fixed objects. The movable arm can be a robot arm, for example. The movable arm can move in space (i.e., in three dimensions) at least in sections. The movable arm can be a robot arm. The movable arm can be mounted on the fixed base by means of a joint. Furthermore, the movable arm can have a plurality of joints so that the movable arm can be freely positioned in space. Furthermore, the movable arm can have a large number of lower arms, each of which is connected to at least one adjacent lower arm by a joint. This means that even complicated movement patterns can be easily performed with the movable arm. The function end can be a functional section configured to perform a specific function. In the present embodiment, the function end is configured to hold the label. For example, the function end can hold the label by means of mechanical, magnetic, pneumatic and/or hydraulic force. Holding can mean that the label can be displaced in space together with the function end. In other words, the function end can determine the position at which the label held by it is located. Furthermore, the function end can be configured to actively pick up the label (i.e., transfer it to the held state) and actively push the label off so that it is no longer held. The movable arm can be displaced between a hold state, in which a label is held on the function end, and an application state, in which the function end comes into contact with the piece good in order to apply the label to the piece good. The hold state can be any state of the movable arm in which a label is held at the function end and in which the movable arm is not in contact with the piece good. The application state can realize a mechanical contact between the function end and the piece good. This allows the label to be applied securely to the piece good. The application state can be any state of the movable arm in which the function end is in contact with the piece good. In other words, the movable arm can be configured to be movable so as to bring the function end into such a spatial position that it can come into contact with the piece good. In other words, the movable arm can be configured to be displaceable in such a way that it can individually adapt the application of the label to a piece of good. Optionally, the movable arm is configured to exert a force on the piece good in the application state. This can ensure that the label is applied to the piece good in a satisfactory manner. Particularly in the case of uneven surface shapes of the piece goods, pressure on the piece goods can ensure that the label is satisfactorily applied to the piece goods.

Optionally, the function end is configured to hold the label by means of vacuum. In other words, in the hold state, the label can be held at the function end by means of vacuum. This allows the label to be sucked in while the movable arm is in the hold state. This means that even rapid movements of the movable arm can be realized without the label falling off the function end.

Optionally, the function end has at least one suction gripper. A suction gripper can generate a holding force that is a product of the difference between the ambient pressure and the vacuum provided and the effective suction surface (i.e., the effective surface of the suction gripper impacted by a vacuum). A suction gripper can be an elastic element that can realize an airtight contact between the label and a vacuum-generating device. Furthermore, the suction gripper can have a collar element that can reliably ensure airtight contact between the function end and the label.

Optionally, the function end has an elastic holding element that is configured to hold the label in a holding state in a holding plane. The advantage of an elastic holding element is that it can be adapted to a label and/or to a piece good (i.e., to an outer surface of the piece good). This ensures that there is always secure contact between the label and the function end and/or between the function end and the surface of the piece good. Furthermore, the elastic holding element can compensate for positional inaccuracies of the function end. As a result, a faster movement of the movable arm can be realized.

Optionally, the function end has an elastic holding element that is configured to adapt the holding plane to the outer shape of the piece good in the application state. In other words, the elasticity of the holding element can be used to adapt the holding plane to an outer surface of the piece good. For example, if the piece good is a transport roll with an outer surface that is at least partially circular, the holding element can adapt to this circular surface and satisfactorily press the label onto such an outer shape itself. This can ensure that the label is always satisfactorily applied to a wide range of different piece goods. In other words, the elastic holding element can be configured to adapt to a wide range of different external shapes of piece goods.

Optionally, the function end is configured to come into mechanical contact with the piece good in the application state. The mechanical contact can be regarded as physical contact between the function end and the piece good. The contact between the function end and the piece good can be indirect, with the label interposed. In other words, the function end can be in direct contact with the label, whereby the label in turn is in contact with the piece good. The mechanical contact is intended to ensure that the label is not just blown onto a piece of good or applied without contact by other actuators, but can be applied by actual physical contact. This can improve optimum adhesion of the label to the piece good. Furthermore, adhesion can also be ensured with uneven surfaces of the piece goods.

Optionally, during the application state, the function end is configured to eject the label from the function end using compressed air. In other words, in addition to the physical contact between the function end and the piece good, a further measure can be provided to ensure the detachment of the label from the function end. The compressed air can ensure that the label detaches satisfactorily from the function end and is not still partially attached to it. This could be disadvantageous if the function end is moved away from the piece good after the application state and may damage the label or even tear it off completely. This is particularly advantageous for labels that have a certain surface roughness, so that the function end could adhere to them more easily.

Optionally, the function end is configured to have a different shape in the application state than in the hold state. For example, by changing its shape, the function end can ensure that the label detaches easily from the function end. For example, it is conceivable that a contact surface between the function end and the label is changed by the contact between the function end and the piece good (i.e., indirect contact) in such a way that the contact surface is reduced. This can make it easier to detach the label from the function end. It is also conceivable, for example, that the shape of a suction gripper changes when it is placed on a piece of good and is thus deformed depending on the outer surface of the piece of good. As a result, the suction gripper can have a different shape in the application state than in the hold state. This provides the technical effect that the label can be optimally adapted to the piece good and can therefore also optimally adapt to the piece good.

Optionally, the label device also has a label output that is fixed relative to the stationary base bearing. The label output can, for example, be a label printer or label printer that is configured to print and output just-in-time labels that are to be applied to piece goods to be handled. Optionally, the label output can have a slot-like opening through which the label is at least partially exposed so that the function end can grip the label. The label output can be fixed in position relative to the fixed base layer. In other words, the label dispenser can be arranged in a fixed position. The movable arm makes it possible to efficiently take over the labels that are output by the label output and feed them to the function end of the movable arm. This allows the movable arm to obtain the labels and then apply them to the piece goods.

Optionally, the movable arm can also be moved to a label transfer state, in which a label is transferred from the label output so that the label is held at the function end. In other words, the movable arm can move spatially to the label output and pick up an output label there with the function end. For example, the function end can suck in a printed label by means of vacuum and thus hold it at the function end. In this way, the label transfer state can take place before the hold state.

Optionally, the vacuum applied to the function end is greater during the label transfer state than during the hold state. This can ensure that the label is transferred satisfactorily from the label dispenser to the function end and that the movable arm can be moved quickly in the direction of the piece good. It can also ensure that the label detaches from a substrate in the label dispenser. A low vacuum during the hold state also improves the overall effectiveness of the label device. Furthermore, this prevents damage to the label during the hold state.

Optionally, the movable arm is configured to follow, at least temporarily, a path of movement of a piece good to be labeled in the application state. In other words, the piece goods to be labeled can be moved at least temporarily along the labeling device. In other words, the labeling device can be positioned on a transport device for piece goods and, during normal operation of the transport device, provide the piece goods transported thereon with labels. In such a transport device, different ways of transporting piece goods can prevail. For example, the piece goods can all be guided past the label device in the same orientation and always at the same point. In this case, it is easy to move the movable end, as the destinations (i.e., the position of the movable arm in the application state) are known from the outset. However, piece goods can also be fed to the labeling device in any position (for example with a wider transport device). In addition, the orientation of the piece goods can vary. In other words, one piece good can be transported with one edge first, while another piece good is transported with its longest side first. The possibility of at least temporarily following the path of movement of a piece good to be labeled makes it possible to label a piece good during transport without having to slow down the transport device or even stop the piece good. This can significantly increase the efficiency of labeled piece goods (e.g., per hour). The path of movement of a piece good can mean a trajectory or path line that describes the piece good in space.

Optionally, the label device has a control unit which is configured to obtain or detect label information and, based on this, to control the movable arm and/or the function end in such a way that the label can be applied to the piece good based on the label information. The control unit can be a computer-like device that is configured to receive data, process data and output data. The label information can include information about the piece good that can directly and/or indirectly influence the labeling in some way. This in information can be supplied to the control unit either from a memory (for example, in the case where the piece goods are always supplied to the label device in a known manner) and/or by previous handling processes of the piece goods. In other words, in this case it may not be necessary to collect the label information yourself. Alternatively or additionally, the control unit can collect the label information itself, for example by individually determining a position of the piece good on the transport device for each piece good. Regardless of how the label information is provided to the control unit, it can be used to apply the label to the piece good. For example, the application state can be varied depending on the type of piece good. For example, if a piece good is a relatively soft, formable item (such as a polybag or a shipping bag), the application state can be characterized differently than in a case where the piece good has a relatively non-formable outer shape (for example, a parcel or package). In particular, the contact pressure of the function end on the piece good may differ. While a high contact pressure can lead to damage in the case of a formable piece good, such pressure can be easily absorbed in the case of a non-formable piece good. Furthermore, a position where the label is applied to the piece good can be selected depending on the label information. Overall, by taking the label information into account, it can be ensured that even piece goods that need to be labeled individually can be labeled satisfactorily and automatically without errors occurring.

Optionally, the label device has a sensor device which is configured to detect a piece good to be labeled in order to obtain label information. In other words, the labeling device itself can have a sensor system to detect the label information of a piece good to be labeled. The sensor device can be a camera system, for example, which is arranged adjacent to the transport device. Optionally, the sensor device can scan from vertically above the transport device. The camera system or vision system can optically detect a piece good to be labeled. At least one piece of label information can then be determined based on the images obtained. For example, a classifier can be used for this purpose, which outputs at least one piece of label information based on the captured images. Furthermore, a learning algorithm can also be used to determine the label information so that the system can also be adapted to a changing piece goods bandwidth.

Optionally, the label information includes a dimension of the piece good to be labeled. A dimension can be, for example, an extension of the piece good in at least one spatial direction.

Optionally, all dimensions of the piece good are recorded in three spatial directions. This allows a three-dimensional shape of the piece good to be determined. This provides the advantage that the labeling process can be individually adapted to the piece good. For example, the optimum position for the label on a piece good can be determined.

Optionally, the label information includes a path of movement of the piece good to be labeled. Based on how the piece goods are transported on the transport device, it is possible to calculate in advance where the piece goods will be located at what time. This makes it possible to determine in advance the path of movement that must be followed by the moving arm, for example. This means that the label can be individually applied to the piece good even while it is moving.

Optionally, the at least one piece of label information comprises a position of the piece good transverse to a transport direction and/or a tilt angle of the piece good relative to the transport direction. This allows the position of the piece good on the transport device to be determined. This means that the labeling device can be arranged at any point in the handling process of a piece good, as it is not necessary for the piece goods to be oriented in a certain predefined way. Rather, the piece goods can be oriented in any way and the label device can adapt to the respective piece good.

Optionally, the movable arm has four axes and four degrees of freedom. The movable arm can be a SCARA robot (abbreviation for “Selective Compliance Assembly Robot Arm”), for example. This can be, for example, an industrial robot with a structure similar to a human arm. The movable arm can also be a horizontal articulated arm robot. All axes can be designed as serial kinematics. In other words, the coordinate origin of a subsequent arm can only be dependent on the position of the previous arm. For example, in a movable arm with four lower arms, the first and second arms can be of a rotational nature, while the third and fourth arms can often be made from a single component. In this way, rotational and linear movement can be permitted. The working range of the movable arm can optionally be kidney-shaped. Optionally, the longest extension of the working area extends along the conveying direction of the conveyor device. This can provide sufficient opportunity to apply labels to the piece goods as they are transported past the working area of the labeling device.

The axles are optionally configured as serial kinematics. In this case, an axle can describe a lower arm of the moving arm.

Optionally, the label device is configured to recognize the surface of a piece good and determine an order for the label based on this. The information about the surface condition of a piece good can be determined by the label device itself or obtained from an external source. Regardless of this, an optimum application point for the label can be determined based on the surface of the piece good. For example, piece goods may have a large number of other labels or stickers already applied to them. In such a case, it is advantageous not to stick the label to be applied over another label. This can lead to problems in the subsequent mail run. Therefore, recognizing the surface of the piece good has the advantage that the position of the label can be determined taking into account labels that have already been applied to the piece good. Furthermore, unevenness or projections on a piece good can be detected and avoided as an application point. This can ensure that the label is not applied to the piece good at an unfavorable position for application.

Optionally, the label device can be configured to recognize a position of an applied label and store the result in the label information. In other words, a suitable position for the label can be saved in a database and stored together with another label information. This offers the advantage that the optimum position for the label can be determined quickly if the same piece of good is encountered again. Furthermore, a database can be built up in this way, allowing the system to deliver a significantly increased throughput rate for a certain range of items after a certain learning period.

According to a further aspect of the present disclosure, a labeling system is provided, wherein the labeling system comprises: A labeling device according to one of the above embodiments. Further, the labeling system may comprise a conveyor configured to transport piece goods in a transport direction to the labeling device. The conveyor can be the conveyor device, which is configured to convey piece goods in the transport direction. The conveyor can run through a working area of the movable arm. The labeling device can be provided adjacent to the conveyor. The conveyor can be configured to transport piece goods on it relative to the fixed base. Optionally, the conveyor has a width of approximately 400 mm transverse to the conveying direction. This can ensure that a wide range of different piece goods can be transported. Optionally, the conveyor has a transport speed of approximately 1 m/s. With this speed, a significant increase in the efficiency of the labeling device can be achieved compared to the known state of the art. Optionally, the label system is also equipped with a sensor system that is configured to obtain label information. In one embodiment, the sensor system can be a vision system that can optically determine the properties of the piece goods.

According to another aspect of the present disclosure, a method of applying a label to a piece good is provided. The method may comprise holding a label at a function end of a movable arm in a hold state. Further, the method may comprise applying the label to a piece good by means of contact between the function end and the piece good in an application state.

According to a further aspect of the present disclosure, there is provided a use of a label device according to one of the above embodiments for applying a label to a mail piece.

Individual embodiments or features can be combined with other embodiments or other features to form a new embodiment. Advantages and embodiments that are mentioned in connection with the embodiment or the features also apply analogously to the new embodiments. Advantages and embodiments mentioned in connection with the device also apply analogously to the method and vice versa.

### BRIEF DESCRIPTION OF THE DRAWINGS

In the following, an object of the present disclosure is described in detail with reference to the attached figures.

FIG. 1 is a schematic and perspective view of a label system according to one embodiment of the present disclosure;

FIG. 2 is a schematic flow chart of a method according to one embodiment of the present disclosure;

FIG. 3 is a schematic view of the function end 5 in a hold state; and

FIG. 4 is a schematic and perspective view of a function end in an application state.

### DETAILED DESCRIPTION OF THE PREFERRED EMBODIMENTS

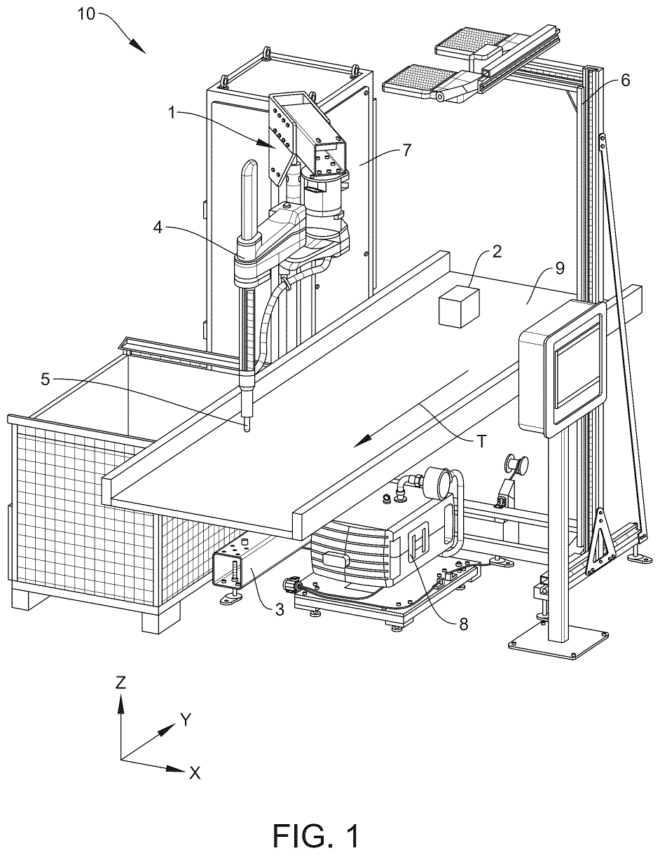

FIG. 1 shows a label device 1 according to an embodiment of the present disclosure.

The label device 1 has a movable arm 4 which is movably mounted on a fixed base 3. In the present embodiment, the movable arm 4 is a robot arm. A function end 5 in the form of a suction gripper is arranged at the end of the movable arm 4. The label device 1 of the present embodiment is part of a label system 10. The label system 10 has a sensor system 6. The sensor system 6 is an optical sensor unit that can detect piece goods 2 that are transported on a transport device 9 in a transport direction T. Furthermore, the label system has a label output 7, which is configured to print and output labels. The function end 5 of the movable arm 4 can pick up the label 2 from the label output 7 and transport it to piece goods 2, which are transported on the transport device 9 in the transport direction T. This transport process can be referred to as the hold state of the label device. In the hold state, the label device or the movable arm can hold the label 2 and transport it to a desired position in space (an application point on a piece good). During the application state, the function end is in mechanical or physical contact with the piece good 2 in order to press the label 12 onto the piece good. This enables a particularly good hold to be achieved. Furthermore, the label system has a vacuum device 8, which is configured to impact the function end 5 with a vacuum.

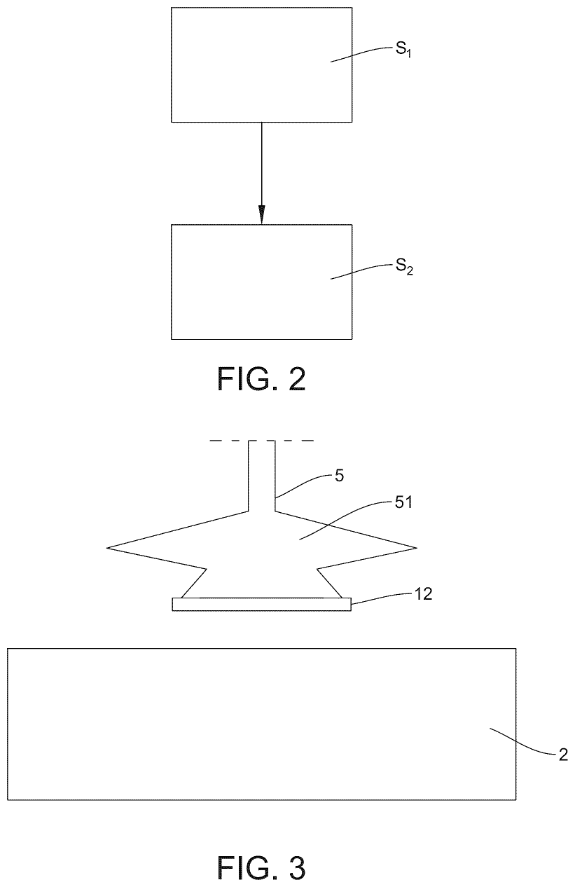

FIG. 2 is a schematic flowchart of a method according to one embodiment of the present disclosure. In step S1, the label 12 is held at a function end 5. In other words, in the first step, the label 12 is held on the movable arm 4 and transported to a desired position. In step S2, the label is applied to the piece good 2 by means of physical contact between the function end 5 and the piece good 2. The physical contact ensures sufficient application of the label to the piece good. Optionally, the applied label can be checked in a further step, in that the position and/or quality of the application of the label is checked by an optical sensor device. This can determine whether the label is sufficiently firmly attached to the piece good. Furthermore, the position of the label can be checked, for example whether other labels are covered. The result of this check can be stored together with other label information and taken into account again during the next labeling process. In this way, feedback control can be provided, which can ensure continuous improvement of the labeling process.

FIG. 3 is a schematic side view of the function end 5 in the hold state. More precisely, in the hold state, a label 12 is held on the function end 5. In the present embodiment, the function end has a suction cup 51. The suction cup 51 is elastically formable and can adapt to the surface contour of a piece of good. The holding position shown in FIG. 3 is the position of the function end in which the label 12 is held but no contact is made with the piece good 2.

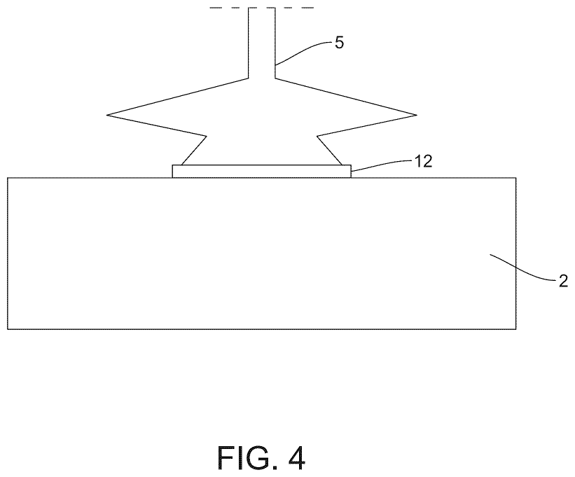

FIG. 4 is a schematic side view of the function end 5 in the application state. In FIG. 5, the function end 5 is indirectly in contact with the piece good 2 via the label 12. In this application state, the function end 5 exerts an impression on the piece good 2. As a result, the label 12 can be satisfactorily applied to the surface of the piece good 2. This prevents the label 12 from peeling off. Furthermore, a label 12 can even be applied to uneven surfaces of piece goods 2.

### LIST OF REFERENCE SYMBOLS

1 Label device
2 Piece good
3 Fixed base
4 Movable arm
5 Function end
6 Sensor system
7 Label issue
8 Vacuum device
9 Transport device
10 Label system
12 Label
51 Suction cup

The invention claimed is:

1. A label device for applying a label to a piece good, comprising:
a fixed base;
a movable arm movably mounted on the fixed base; and
a function end provided on the movable arm, wherein the function end is configured to hold a label;
wherein the movable arm is displaceable between a hold state, in which a label can be held on the function end, and an application state, in which the function end can come into contact with the piece good to apply the label to the piece good.

2. The label device according to claim 1, wherein the function end is configured to hold the label via a vacuum.

3. The label device according to claim 2, wherein the function end is configured to come into mechanical contact with the piece good in the application state.

4. The label device according to claim 3, wherein the function end is configured to have a different shape in the application state than in the hold state.

5. The labeling device according claim 4, wherein the movable arm is configured to follow, at least temporarily, a path of movement of a piece good to be labeled in the application state.

6. The label device according to claim 5, further comprising:
a control unit which is configured to obtain or detect label information and, based thereon, to control the movable arm and/or the function end such that the label can be applied to the piece good based on the label information.

7. The label device according to claim 6, further comprising:
a sensor device configured to detect a piece good to be labeled in order to obtain label information.

8. The label device according to claim 7, wherein the label device is configured to recognize a position of an applied label and to store the result in the label information.

9. The label device according to claim 1, wherein the function end is configured to come into mechanical contact with the piece good in the application state.

10. The label device according to claim 1, wherein the function end is configured to have a different shape in the application state than in the hold state.

11. The labeling device according to claim 1, wherein the movable arm is configured to follow, at least temporarily, a path of movement of a piece good to be labeled in the application state.

12. The label device according to claim 1, further comprising:
a control unit which is configured to obtain or detect label information and, based thereon, to control the movable arm and/or the function end such that the label can be applied to the piece good based on the label information.

13. The label device according to claim 1, further comprising:
a sensor device configured to detect a piece good to be labeled in order to obtain label information.

14. The label device according to claim 1, wherein the label device is configured to recognize a position of an applied label and to store the result in the label information.

15. A label system, comprising:
a labeling device according to claim 1; and
a conveyor which is configured to transport piece goods in a transport direction to the label device.

16. A method of applying a label to a piece good, comprising:
holding a label at a function end of a movable arm in a hold state; and
applying the label to a piece good via contact between the function end and the piece good in an application state.
